(19) United States
(12) Patent Application Publication
(10) Pub. No.: US 2007/0099799 A1
(43) Pub. Date: May 3, 2007

(54) Herbicide composition

(75) Inventors: Kang-Chi Lin, Taichung City (TW); Jeff Liu, Taichung City (TW); Chi-Lung Lin, Taichung City (TW)

Correspondence Address: BACON & THOMAS, PLLC, 625 SLATERS LANE, FOURTH FLOOR, ALEXANDRIA, VA, 22314, US

(73) Assignee: Sinon Corporation, Taichung City (TW)

(21) Appl. No.: 11/398,678

(22) Filed: Apr. 6, 2006

(30) Foreign Application Priority Data
Oct. 28, 2005 (TW) 94137861

(51) Int. Cl. A01N 43/40; A01N 25/04; A01N 25/16

(52) U.S. Cl. 504/245; 504/250; 504/366

(57) ABSTRACT

The present invention relates to an herbicide composition, which adds bismuth gelatinzer to a bipyridylium diquaternary salt. Bismuth gelatinzer will form a protecting membrane of a colloidal or dispersed object on the surface of stomach tissue; it is capable of lowering the absorption of bipyridylium diquaternary compound to gastrointestinal tracks then reducing the oral toxicity of bipyridylium diquaternary herbicide.

### BACKGROUND OF THE INVENTION

1. Field of the Invention

The present invention relates to a herbicide composition and, more particularly, to a herbicide of bipyridylium diquaternary salt adding bismuth gelatinzer.

2. Description of Related Art

Currently, there are various herbicides of bipyridylium diquaternary salt, for example, UK patent No.785732, 813531, 813532; generally, the products of herbicide usually be sold in the way of aqueous solution and it is usually diluted by adding water and ready to spray. The herbicide is used for preventing weeds and the mechanism of function is to destroy the organization of green plants by killing and the specific infectivity after applying the herbicide, it is provided with good preventing effects to various weeds.

This herbicides are harmless if they were used follow—by the instruction, but it usually causes misdrunk by various reasons. In recent years, in order to prevent misdrinking, they were added with blue pigments for warning and adds stench in the same time (for example, disclosed in UK Patent Nos. 1406881 and 1570981) for enhancing the cautioning function. Probably add thixotropic gel (UK Patent No.1395502) for increasing the rheidity. Sometimes they were added with emetics in order to make the herbicide can be throw out rapidly to further improve the safety. (UK Patent No.1507407) The stipulation of The Food and Agriculture Organization of the United Nation in 2003 states that the ratio of adding 2-amino-4, 5-dihydro-6-methyl-4-propyl-s-triazole-[1, 5-a] pyrimidine-5-one to paraquat dichloride should be comprised with at least 0.8 g/L Technical concentrate; TK, the liquid product should at least comprise a volume of 0.4 g/L.

On the other hand, EP 0467529, GB 2263037 and CA 2440360 disclosed that adding magnesium trisilicate and alginate as the gelatinzer to form gelatin after the reaction with hydrochloric acid in gastric juice.

### SUMMARY OF THE INVENTION

In order to decrease the damage speed to the digestive system and human body, the object of the present invention is to provide a herbicide composition, which is capable of forming a protective membrane on the inner surface of stomach tissue to decrease the damage of herbicide contacts the stomach tissue directly and make sure the effective medical timing of misdrinking herbicides.

To achieve the object, the herbicide composition of present invention includes a bipyridylium diquaternary salt as the main composition; and the feature of the herbicide is provided with bismuth gelatinzer.

Wherein, the bipyridylium diquaternary salt comprises paraguat, diquat or a mixture thereof; the bismuth gelatinzer comprises colloidal bismuth pectin, bismuth potassium citrate or a mixture thereof.

The present invention further provides a method of preparing the herbicide composition, which comprises the following steps: (a) providing a solution which comprises bipyridylium diquaternary salt; (b) adjusting the pH value of said solution to 6.5˜7.5; and (c) adding a bismuth gelatinzer to said solution prepared from step (b) to obtain herbicide composition.

Wherein, the bipyridylium diquaternary salt comprises paraguat, diquat or a mixture thereof; the bismuth gelatinzer comprises colloidal bismuth pectin, bismuth potassium citrate or a mixture thereof.

The present invention applies with the mechanism of acid trigger gelation. It starts up the gelation and disseminating effect by the low pH value of human stomach acid. The gelatinized object after gelation effect is provided with viscosity and sprayed inside the gastrointestinal tract, which forms a physical protection and is able to trap bipyridylium herbicide in order to ease the evacuation of stomach and decrease the entering speed of bipyridylium herbicide to gastrointestinal tract. It is formed a quarantined layer to separate the bipyridylium herbicide from stomach wall when applies with bismuth potassium citrate; further to cooperate with emetics for encouraging vomit, the entering speed of bipyridylium herbicide to the human blood will be decreased according to the three effects mentioned above and achieve the purpose of decreasing the oral toxicity of bipyridylium herbicide. Compare with the prior arts in the field, the present invention is cable of adding the protector of gastrointestinal mucous membrane (the bismuth gelatinzer of present invention) to herbicides and decreasing the absorption of herbicide by the forming of protection membrane and evacuation effect in the same time. It is obviously that the present invention is provided with different mechanism and effect from the mechanism of the gelatinzer of prior art by decreasing the herbicide toxicity merely with the evacuation effect.

Other objects, advantages, and novel features of the invention will become more apparent from the following detailed description when taken in conjunction with the accompanying drawings.

### DETAILED DESCRIPTION OF THE PREFERRED EMBODIMENT

The herbicide composition of present invention includes a bipyridylium diquaternary salt as the main composition; and the feature of the herbicide is provided with bismuth gelatinzer.

The embodiments of bipyridylium diquaternary salt include, but not limit to 1,1′-dimethyl-4, 4′-bipyridylium cation (paraquat), 1,1′-ethylene-2,2′-bipyridylium cation (diquat) or the mixture thereof. Generally, herbicide comprises 40˜360 g bipyridylium diquaternary salt per liter, preferably, comprises 100˜200 g bipyridylium diquaternary salt per liter. The formulas of mentioned paraquat and diquat are shown as follow:

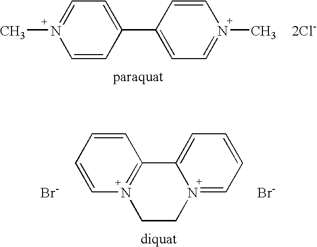

The bipyridylium diquaternary salt above synthesizes salts with anion in the known skill, but it only estimates the part of cation when calculates the concentration. Because cation is provided with the activity of weeding, the herbicide concentration of present specification is the volume of cation unless for specific statement.

In the preferred embodiment, the -bismuth gelatinzer of the present invention includes, but not limit to colloidal bismuth pectin, bismuth potassium citrate or a mixture thereof, wherein that the colloidal bismuth pectin is a sort of colloidal bismuth reagent, which is a salt formed with a biological large molecule pectic acid (D-polygalacturonic acid) and metal bismuth ion and potassium ion, it is also called colloidal bismuth pectin, wei-min; which comprises a trivalent bismuth complex with no specific structure, the formula is [KBiC₁₂H₁₀O₈(OH)₆]n, the general appearance of the compound is like yellow powder or particles. The colloidal bismuth pectin is provided with stronger colloidal properties and able to form a layer of firm protecting membrane in order to enhance the protecting effect of stomach mucous membrane. Bismuth potassium citrate is also called bismuth potassium citrate, colloidal bismuth subcitrate, tripotassium dicitratobismuthate DE-NOL, the general appearance of bismuth potassium citrate is like white powder or particles, it is provided with specific function mode, it neither neutralizes the stomach acid nor restrains the secretion of the stomach acid. The bismuth potassium citrate is able to form a firm precipitative gel of bismuth trioxide, which becomes a protective membrane for protecting the ulcerated mucous membrane from the corroding of stomach acid and food. The detail information about the colloidal bismuth pectin and bismuth potassium citrate can be found in Chinese pharmacopoeia.

The herbicide composition of present invention comprises 1˜100 g bismuth gelatinzer per liter, preferably, comprises 1˜50 g bismuth gelatinzer per liter.

The herbicide composition of present invention further comprises pigment, stench, emetic, thickener, diarrhoea reagent, surfactant or the mixture thereof, which are known in the art and used in the additive for mixing, warming and avoiding misapplication.

The present invention also provides a preparing method of herbicide composition, which comprises the step of providing a solution, which comprises bipyridylium diquaternary salt; the practical embodiment of bipyridylium diquaternary salt includes, but not limits to paraguat, diquat or the mixture thereof. The -solution comprises 40˜360 g bipyridylium diquaternary salt per liter, preferably, 100˜200 g bipyridylium diquaternary salt per liter. The solution further comprises pigment, stench, emetic, thickener, diarrhoea reagent, surfactant or a mixture thereof, which are known in the art and used in the additive for mixing, warming and avoiding misapplication.

And then adjust the pH value of the solution above to 6.5˜7.5, generally, the solution is tend to slight acid. The adjusting method is adding weak base, for example, adjust the pH value of solution to 6.5˜7.5 by ammonia, then add bismuth gelatinzer to the adjusted solution in order to obtain the herbicide of present invention. The practical embodiment of bismuth gelatinzer includes, but not limit to colloidal bismuth pectin, bismuth potassium citrate or the mixture thereof. The adding volume of the final product of herbicide composition of present invention is 1˜100 g per liter, preferably, 1˜50 g per liter. 17. The herbicide composition of present invention further comprises a thickener for adjusting the viscosity of the composition.

Although the present invention has been explained in relation to its preferred embodiment, it is to be understood that many other possible modifications and variations can be made without departing from the spirit and scope of the invention as hereinafter claimed.

### EXAMPLE

### Example 1

Herbicide Composition 1

TABLE 1

| Composition | Function | Volume |
|---|---|---|
| paraguat ion | herbicide | 200 g |
| 2-amino-4,5-dihydro-6-methyl-4-propyl- | emetic | 0.5 g |
| s-triazole-[1,5-a]pyrimidine-5-one | | |
| NP-8** | surfactant | 3.55 g |
| Blue dye | pigment | 0.17 g |
| LAS*** | surfactant | 5.90 g |
| Pyridine base | stench | 1 g |
| Colloidal bismuth pectin | gelatinzer | 2.15 g |
| Kelzan**** | thickener | 0.22 g |

*The final volume is adding water to 1 liter.
**NP-8 is a surfactant comprises condensed Nonyl phenol and 8 mole fraction Ethylene oxide.
***LAS is a surfactant comprises 60% Linear alkylbenzene sulfonate
****Xanthan gum is comprised as a suspending agent, which the anion is replace by polysaccharide, it is used as a thickener here.

Mix the labeled volume 1 to 6 in Table 1; adjust the pH value by ammonia to 6.5˜7.5, then mix with the labeled volume of colloidal bismuth pectin in Table 1, add Kelzan in order to adjust the viscosity of composition. The herbicide composition 1 of present invention is obtained.

### Example 2

Herbicide Composition 2

TABLE 2

| Composition | Function | Volume |
|---|---|---|
| paraguat ion | herbicide | 200 g |
| 2-amino-4,5-dihydro-6-methyl-4-propyl-[1, | emetic | 0.5 g |
| s-triazole-5-a]pyrimidine-5-one | | |
| NP-10** | surfactant | 3.55 g |
| Blue dye | pigment | 0.17 g |
| LAS*** | surfactant | 5.90 g |
| Pyridine base | stench | 1 g |
| Bismuth potassium citrate | gelatinzer | 2.15 g |
| Kelzan**** | thickener | 0.22 g |

*The final volume is adding water to 1 liter.
**NP-10 is a surfactant comprises condensed Nonyl phenol and 10 mole fraction Ethylene oxide.
***LAS is a surfactant comprises 60% Linear alkylbenzene sulfonate
****Xanthan gum is comprised as a suspending agent, which the anion is replace by polysaccharide, it is used as a thickener here.

Mix the labeled volume 1 to 6 in Table 2; adjust the pH value by ammonia to 6.5˜7.5, then mix with the labeled volume of colloidal bismuth pectin in Table 2, add Kelzan in order to adjust the viscosity of composition. The herbicide composition 2 of present invention is obtained.

### Example 3

Herbicide Composition 3

TABLE 3

| Composition | Function | Volume |
|---|---|---|
| paraguat ion | herbicide | 200 g |
| 2-amino-4,5-dihydro-6-methyl-4-propyl-s-triazole- | emetic | 0.50 g |
| [1,5-a]pyrimidine-5-one | | |
| NP-10** | surfactant | 3.55 g |
| Blue dye | pigment | 0.17 g |
| LAS*** | surfactant | 5.90 g |
| Pyridine base | stench | 1.00 g |
| Bismuth potassium citrate | gelatinzer | 2.15 g |
| Colloidal bismuth pectin | gelatinzer | 0.22 g |
| Kelzan**** | thickener | 0.22 g |

*The final volume is adding water to 1 liter.
**NP-10 is a surfactant comprises condensed Nonyl phenol and 10 mole fraction Ethylene oxide.
***LAS is a surfactant comprises 60% Linear alkylbenzene sulfonate
****Xanthan gum is comprised as a suspending agent, which the anion is replace by polysaccharide, it is used as a thickener here.

Mix the labeled volume 1 to 6 in Table 3; adjust the pH value by ammonia to 6.5˜7.5, then mix with the labeled volume of Bismuth potassium citrate and colloidal bismuth pectin in Table 3, add Kelzan in order to adjust the viscosity of composition. The herbicide composition 3 of present invention is obtained.

As the mention above, to open the mechanism of starting up by stomach acid (human stomach acid comprises a pH value between 1.5˜2.5, usually is 2N hydrochloric acid), making colloidal bismuth pectin for forming a better soluble colloidal object in order to form an effective protecting membrane to separate stomach acid. Bismuth potassium citrate will form a dispersed insoluble bismuth oxide colloidal object; the gastrointestinal tract is not able to absorb the colloidal object easily, the colloidal object then precipitates and forms a protecting layer to cover on the stomach tissue for separating the stomach acid, it is capable of lowering the absorption of bipyridylium diquaternary herbicide to stomach then reducing the oral toxicity of bipyridylium diquaternary herbicide.

Other Embodiments

The preferred embodiments of the present invention have been disclosed in the examples. All modifications and alterations without departing from the spirits of the invention and appended claims, including the other embodiments shall remain within the protected scope and claims of the invention.

The preferred embodiments of the present invention have been disclosed in the examples. However the examples should not be construed as a limitation on the actual applicable scope of the invention, and as such, all modifications and alterations without departing from the spirits of the invention and appended claims, including the other embodiments shall remain within the protected scope and claims of the invention.

What is claimed is:

1. A herbicide composition comprising:
a bipyridylium diquaternary salt; and
a bismuth gelatinzer

2. The herbicide composition of claim 1, wherein said herbicide composition comprises 40˜360 g bipyridylium diquaternary salt per liter.

3. The herbicide composition of claim 2, wherein said herbicide composition comprises 100˜200 g bipyridylium diquaternary salt per liter.

4. The herbicide composition of claim 1, wherein said bipyridylium diquaternary salt comprises paraguat, diquat or the mixture thereof.

5. The herbicide composition of claim 1, wherein said herbicide composition comprises 1˜100 g bismuth gelatinzer per liter.

6. The herbicide composition of claim 5, wherein said herbicide composition comprises 1˜50 g bismuth gelatinzer per liter.

7. The herbicide composition of claim 1, wherein said bismuth gelatinzer comprises colloidal bismuth pectin, bismuth potassium citrate or a mixture thereof.

8. The herbicide composition of claim 1, further comprising pigment, stench, emetic, thickener, diarrhoea reagent, surfactant or a mixture thereof.

9. A preparing method of herbicide composition, which comprises the following steps:
(a) providing a solution which comprises bipyridylium diquaternary salt;
(b) adjusting the pH value of said solution to 6.5˜7.5; and
(c) adding a bismuth gelatinzer to said solution prepared from step (b) to obtain a herbicide composition.

10. The method of claim 9, wherein said solution of step (a) comprises 40˜360 g bipyridylium diquaternary salt per liter.

11. The method of claim 10, wherein said solution of step (a) comprises 100˜200 g bipyridylium diquaternary salt per liter.

12. The method of claim 9, wherein said bipyridylium diquaternary salt comprises paraguat, diquat or a mixture thereof.

13. The method of claim 9, wherein said herbicide composition of step (c) comprises a volume of 1˜100 g bismuth gelatinzer per liter.

14. The method of claim 9, wherein said herbicide composition of step (c) comprises 1˜50 g bismuth gelatinze per liter.

15. The method of claim 9, wherein said bismuth gelatinzer comprises colloidal bismuth pectin, bismuth potassium citrate or a mixture thereof.

16. The method of claim 9, wherein said solution of step (a) further comprising pigment, stench, emetic, thickener, diarrhoea reagent, surfactant or a mixture thereof.

17. The method of claim 9, wherein said composition of step (c) further comprising a thickener for adjusting the viscosity of said composition.
